(19) United States
(12) Patent Application Publication
(10) Pub. No.: US 2025/0135662 A1
(43) Pub. Date: May 1, 2025

(54) GRIPPING DEVICE AND CONTROL METHOD BY GRIPPING DEVICE

(71) Applicant: MINEBEA MITSUMI Inc., Nagano (JP)

(72) Inventors: Toshiki KIMURA, Nagano (JP); Yusuke AOKI, Nagano (JP); Reiji YAMASAKI, Nagano (JP)

(21) Appl. No.: 18/684,003

(22) PCT Filed: Aug. 18, 2022
(86) PCT No.: PCT/JP2022/031207

§ 371 Date: Feb. 15, 2024

(30) Foreign Application Priority Data
Aug. 20, 2021 (JP) 2021-135159

(51) Int. Cl. B25J 15/08; B25J 9/16; B25J 13/08

(52) U.S. Cl. CPC B25J 15/08; B25J 9/1612; B25J 9/1633; B25J 13/082

(57) ABSTRACT

A gripping device includes a motor configured to rotate in accordance with an operational value, a grasper including a first finger and a second finger, a force detector configured to detect a grip force that enables an object to be gripped by the first finger and the second finger upon occurrence of a condition in which the object is gripped by the first finger and the second finger, and a controller that controls the operational value such that a magnitude of the grip force detected by the force detector matches a command value. The controller controls the grasper based on the command value as a reference command value. The controller changes the command value as the reference command value to an updated command value based on a change in the grip force that the force detector detects after the grasper grips the object.

### TECHNICAL FIELD

The present disclosure relates to a gripping device and a control method by the gripping device.

### BACKGROUND

When product manufacturing lines are automated using a robot or the like, gripping devices called manipulators or grippers are used to grip objects to be gripped, such as mechanical components or electrical components.

Patent Document 1 discloses a manipulator that includes an article-gripping unit, a drive unit for driving the article-gripping unit, a force sensor for detecting a force applied on the article-gripping unit, and a feedback controller that controls the drive unit based on the output of the force sensor. In the disclosure of Patent Document 1, the controller includes a unit that determines stiffness between an article gripped by the article-gripping unit and a pressed portion based on the force applied to the article-gripping unit and a change in position of the article-gripping unit.

### RELATED-ART DOCUMENT

### Patent Document

Patent Document 1: Japanese Unexamined Patent Application Publication No. H10-264063

### SUMMARY

### Problem to be Solved by the Invention

When gripping individual objects to be gripped, a gripping device may continuously grip these individual objects having different hardness measurements. It is required to accurately and stably hold the object to be gripped each time the gripping device grips the object to be gripped, even if the hardness of the object to be gripped varies.

The present disclosure provides a gripping device capable of gripping an object that is to be gripped and has a different hardness measurement.

### Means for Solving the Problem

In one aspect of the present disclosure, a gripping device includes a motor configured to rotate in accordance with an operational value, a grasper including a first finger and a second finger and configured to grip an object with the first finger and the second finger while changing a distance between the first finger and the second finger by using the motor, a force detector configured to detect a grip force that enables the object to be gripped by the first finger and the second finger upon occurrence of a condition in which the object is gripped by the first finger and the second finger, and a controller configured to output the operational value unit such that a magnitude of the grip force detected by the force detector matches a command value. The controller is configured to set the command value as a reference command value to control the grasper and change the command value as the reference command value to an updated command value based on a change in the grip force that the force detector detects after the grasper grips the object.

### Effects of the Invention

According to a gripping device in the present disclosure, an object that is to be gripped and has a different hardness measurement can be gripped accurately and stably.

### BRIEF DESCRIPTION OF THE DRAWINGS

FIG. 1 is a diagram showing a configuration example of a gripping device according to a first embodiment.

FIG. 2 is a diagram for describing a functional configuration of the gripping device according to the first embodiment.

FIG. 3 is a diagram for describing a functional configuration of an arithmetic processing unit included in a controller of the gripping device according to the first embodiment.

FIG. 4 is a diagram for describing the functional configuration of an operational value calculator of the arithmetic processing unit included in the controller of the gripping device according to the first embodiment.

FIG. 5 is a diagram for describing a functional configuration of an admittance processing unit of the arithmetic processing unit included in the controller of the gripping device according to the first embodiment.

FIG. 6 is a diagram for describing a functional configuration of a position-and-speed calculator of the arithmetic processing unit included in the controller of the gripping device according to the first embodiment.

FIG. 7 is a diagram for describing a functional configuration of a current calculator of the arithmetic processing unit included in the controller of the gripping device according to the first embodiment.

FIG. 8 is a flowchart for describing a process by a force command generator of the arithmetic processing unit included in the controller of the gripping device according to the first embodiment.

FIG. 9 is a diagram for describing the operation of the gripping device according to the first embodiment.

FIG. 10 is a flowchart for describing the process by the force command generator of the arithmetic processing unit included in the controller of the gripping device according to a second embodiment.

FIG. 11 is a diagram for describing the operation of the gripping device according to the second embodiment.

FIG. 12 is a flowchart for describing the process by the force command generator of the arithmetic processing unit included in the controller of the gripping device according to a third embodiment.

FIG. 13 is a diagram for describing the operation of the gripping device according to the third embodiment.

FIG. 14 is a diagram for describing the functional configuration of the gripping device according to a fourth embodiment.

FIG. 15 is a diagram for describing the functional configuration of the arithmetic processing unit included in the controller of the gripping device according to the fourth embodiment.

FIG. 16 is a diagram for describing the functional configuration of the operational value calculator of the arithmetic processing unit included in the controller of the gripping device according to the fourth embodiment.

FIG. 17 is a diagram for describing the functional configuration of a force controller of the arithmetic processing unit included in the controller of the gripping device according to the fourth embodiment.

FIG. 18 is a diagram for describing the functional configuration of the operational value calculator of the arithmetic processing unit included in the controller of the gripping device according to a fifth embodiment.

FIG. 19 is a diagram for describing the functional configuration of a position-command value generator of the arithmetic processing unit included in the controller of the gripping device according to a fifth embodiment.

FIG. 20 is a diagram for describing the functional configuration of the operational value calculator of the arithmetic processing unit included in the controller of the gripping device according to a sixth embodiment.

FIG. 21 is a diagram for describing the functional configuration of the operational value calculator of the arithmetic processing unit included in the controller of the gripping device according to a seventh embodiment.

FIG. 22 is a diagram for describing the operation of the gripping device according to the seventh embodiment.

FIG. 23 is a diagram for describing the operation of the gripping device in a comparative example.

FIG. 24 is a diagram for describing the operation of the gripping device according to the seventh embodiment and the gripping device in the comparative example.

FIG. 25 is a diagram for describing the operation of the gripping device according to the seventh embodiment and the gripping device in the comparative example.

### MODE FOR CARRYING OUT THE INVENTION

### First Embodiment

### <Gripping Device 1>

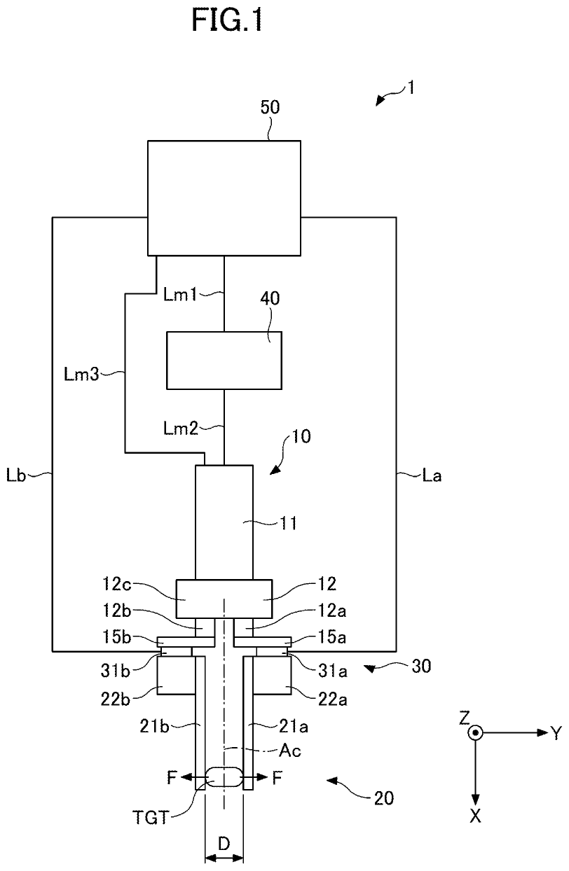

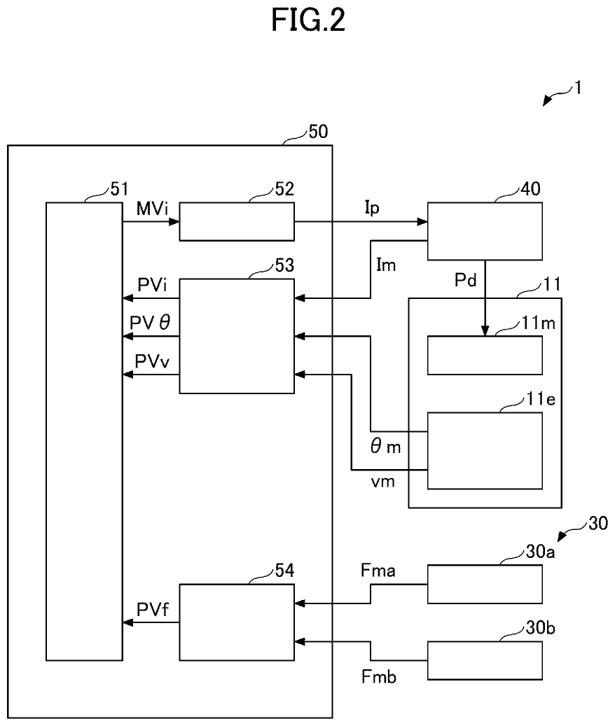

Hereinafter, a gripping device according to the present embodiment will be described in detail with reference to the drawings. FIG. 1 is a diagram showing a configuration example of a gripping device 1 according to the present embodiment. FIG. 2 is a diagram for describing a functional configuration of the gripping device 1 according to the present embodiment.

In FIG. 1, for ease of explanation, virtual three-dimensional coordinate system (XYZ-orthogonal coordinate system), defined by an X-axis, a Y-axis, and a Z-axis (XYZ axes) that are mutually perpendicular, is set. However, the coordinate system is determined for the purpose of explanation, and a posture of the gripping device 1 is not intended to be limiting.

In FIG. 1, an X-axis direction refers to a direction in which a first finger 21a and a second finger 21b extend. In addition, a Y-axis direction refers to a direction in which each of the first finger 21a and the second finger 21b moves. The Z-axis corresponds to a direction perpendicular to the X-axis and the Y-axis.

The gripping device 1 is attached to, for example, an arm tip of a robot, and grips a grip target TGT. Specifically, the gripping device 1 grips the grip target TGT between the first finger 21a and the second finger 21b. The gripping device 1 includes a drive unit 10, a grasper 20, a force detector 30, a motor drive unit 40, and a controller 50. Each component of the gripping device 1 will be described in detail as follows.

The controller 50 and the motor drive unit 40 are coupled to each other by a wire Lm1. The motor drive unit 40 and the drive unit 10 are coupled by a wire Lm2, and more specifically the motor drive unit 40 and the drive unit 10 are the motor drive unit 40 and a power unit 11 (motor 11m) of the drive unit 10. Further, the controller 50 and the drive unit 10 are coupled by a wire Lm3, and more specifically the controller 50 and the drive unit 10 are the controller 50 and the power unit 11 (encoder 11e) of the drive unit 10.

### [Drive Unit 10]

The drive unit 10 changes a distance between the first finger 21a and the second finger 21b. Specifically, the drive unit 10 moves the first finger 21a and the second finger 21b in opposite directions of Y-axis directions.

The drive unit 10 includes the power unit 11 and a motion converter 12. The power unit 11 and the motion converter 12 will be described in detail as follows.

### (Power Unit 11)

The power unit 11 rotates a rotary shaft based on power that is supplied from the motor drive unit 40 via the wire Lm2. The power unit 11 converts the power into rotational motion, and transmits the rotational motion to the motion converter 12.

The power unit 11 includes the motor 11m and the encoder 11e. The motor 11m includes, for example, an alternating current (AC) motor or a stepping motor. The motor 11m rotates the rotary shaft based on the power (supplied power Pd) supplied from the motor drive unit 40. As described below, the supplied power Pd is determined based on a current control value MVi. In this arrangement, the motor 11m rotates based on the current control value MVi. Specifically, the motor 11m has any known configuration of the motor that includes the rotary shaft, a stator, a rotor, and the like.

The encoder 11e detects the position and the rotation speed of the rotary shaft of the motor 11m. The encoder 11e outputs a detection result to the controller 50 via the wire Lm3. The encoder 11e is an example of a detector.

### (Motion Converter 12)

The motion converter 12 converts the rotational motion that is transmitted from the motor 11m, into the linear motion in the Y-axis direction. The motion converter 12 is constituted, for example, by mechanism components such as a gear, a worm gear, and a cam. The motion converter 12 includes a moving unit 12a and a moving unit 12b each of which protrudes from a housing 12c. Each of the moving unit 12a and the moving unit 12b is movable with respect to the housing 12c. The motion converter 12 converts the rotational motion transmitted from the motor 11m into the linear motion that enables the moving unit 12a and the moving unit 12b to move in the Y-axis direction with respect to the housing 12c.

When the motor 11m rotates in one direction, for example, the moving unit 12a moves in a positive Y-direction of Y-axis directions. When the motor 11m rotates in an opposite direction, for example, the moving unit 12a moves in a negative Y-direction of the Y-axis directions. When the motor 11m rotates in one direction, for example, the moving unit 12b moves in the negative Y-direction of the Y-axis directions. When the motor 11m rotates in an opposite direction, for example, the moving unit 12b moves in the positive Y-direction of the Y-axis directions.

That is, when the motor 11m rotates in one direction, the moving unit 12a and the moving unit 12b move in opposite directions of the Y-axis direction. Specifically, the moving unit 12a and the moving unit 12b move in directions that are away from each other in the Y-axis directions. With this arrangement, when the motor 11m rotates in one direction, a greater distance between the moving unit 12a and the moving unit 12b is obtained. When the motor 11m rotates in the opposite direction, the moving unit 12a and the moving unit 12b move in opposite directions of the Y-axis directions. Specifically, the moving unit 12a and the moving unit 12b move in directions in which the moving unit 12a and the moving unit 12b are closer to each other in the Y-axis directions. Thus, when the motor 11m rotates in the opposite direction, a shorter distance between the moving unit 12a and the moving unit 12b is obtained.

As described above, the drive unit 10 can change the distance between the moving unit 12a and the moving unit 12b, in accordance with the rotation of the motor 11m.

### [Grasper 20]

The grasper 20 grips the grip target TGT between the first finger 21a and the second finger 21b, by using the drive unit 10.

The grasper 20 includes the first finger 21a and a first holder 22a for holding the first finger 21a, toward a positive Y-side of the Y-axis direction with respect to a central axis Ac. The first finger 21a is fixed to the first holder 22a. The first holder 22a is fixed to the moving unit 12a via a first force sensor 31a described below. The gripping device 1 includes a fixing unit 15a for fixing the first force sensor 31a to the moving unit 12a.

The grasper 20 includes a second finger 21b and a second holder 22b for holding the second finger 21b, toward a negative Y-side of the Y-axis direction with respect to the central axis Ac. The second finger 21b is fixed to the second holder 22b. The second holder 22b is fixed to the moving unit 12b via a second force sensor 31b described below. The gripping device 1 includes a fixing unit 15b for fixing the second force sensor 31b to the moving unit 12b.

When the moving unit 12a moves in the Y-axis direction, the first finger 21a moves in the Y-axis direction together with the moving unit 12a. Similarly, when the moving unit 12b moves in the Y-axis direction, the second finger 21b moves in the Y-axis direction together with the moving unit 12b. In this arrangement, when the distance between the moving unit 12a and the moving unit 12b varies, a distance D between the first finger 21a and the second finger 21b varies accordingly. By decreasing the distance D between the first finger 21a and the second finger 21b, the grasper 20 grips the grip target TGT, with the first finger 21a and the second finger 21b.

A case where the grip target TGT is gripped by the grasper 20 is limited to a case where the grip target TGT is gripped between the first finger 21a and the second finger 21b. For example, a given grip target having a ring shape may be gripped by moving fingers in a direction from the inside toward the outside of a ring in which the fingers are inserted.

### [Force Detector 30]

The force detector 30 detects a force (grip force) that is applied between the first finger 21a and the second finger 21b, when the grasper 20 grips the grip target TGT. The force detector 30 includes the first force sensor 31a and the second force sensor 31b. Each of the first force sensor 31a and the second force sensor 31b is, for example, a six-axis force sensor.

The first force sensor 31a is coupled to the controller 50 via the wire La. The second force sensor 31b is coupled to the controller 50 via the wire Lb. The force detector 30 uses a detection result on a force in the Y-axis direction that is output from the six axis force sensor.

The first force sensor 31a is fixed to the first holder 22a that holds the first finger 21a. The first force sensor 31a is fixed to the moving unit 12a via the fixing unit 15a. The first force sensor 31a detects a pushing force that the grip target TGT applies on the first finger 21a, when the grasper 20 grips the grip target TGT.

The second force sensor 31b is fixed to the second holder 22b that holds the second finger 21b. The second force sensor 31b is fixed to the moving unit 12b via a fixing unit 15b. The second force sensor 31b detects a pushing force that the grip target TGT applies on the second finger 21b, when the grasper 20 grips the grip target TGT.

The gripping device 1 according to the present embodiment includes the force detector 30 between the drive unit 10 and the grasper 20, but a location where the force detector 30 is provided is not limited to the location between the drive unit 10 and the grasper 20. For example, the gripping device 1 may include the first force sensor 31a and the second force sensor 31b at tips of the first finger 21a and the second finger 21b, respectively.

A type of the force sensor is not limited as long as the force sensor can detect the grip force that is applied between the first finger 21a and the second finger 21b. As the force sensor, for example, a micro electro mechanical systems (MEMS) sensor capable of detecting a force may be used, or a piezoelectric element or a strain gauge may be used. For example, when the MEMS sensor or the strain gauge is used, a flexure element that generates strain by an external force may be used to detect the force, or a portion of the grasper 20 may be used as the flexure element.

The force detector 30 according to the present embodiment includes the first force sensor 31a and the second force sensor 31b, but may include only one of the first force sensor 31a and the second force sensor 31b. That is, the force sensor may be provided in only one of the first finger 21a and the second finger 21b.

### [Motor Drive Unit 40]

The motor drive unit 40 supplies power (supplied power Pd) to the drive unit 10, more specifically the motor 11m, based on an operation command (current control signal Ip) from the controller 50. The drive unit 10 is driven by the power supplied from the motor drive unit 40. The drive unit 10 is driven by the power supplied from the motor drive unit 40, and thus the drive unit 10 operates based on the operation command from the controller 50.

The motor drive unit 40 outputs a current value (drive current value Im) that is derived from the power supplied to the drive unit 10, to the controller 50. The controller 50 controls the drive unit 10, using the current value for the current that the motor drive unit 40 provides to the drive unit 10.

### [Controller 50]

The controller 50 controls the drive unit 10 such that the grip force (each of a first grip force value Fma and a second grip force value Fmb), detected by the force detector 30, becomes a desired grip force. The controller 50 also performs a control using the position (position information Om) and the rotation speed (speed information vm) of the rotary shaft that are detected by the encoder 11e, and using a current signal (drive current value Im) from the motor drive unit 40.

The controller 50 is implemented by a micro-processing unit that includes a central processing unit (CPU), a random access memory (RAM), and a read only memory (ROM), for example. The controller 50 performs processing when the CPU loads a program recorded in the ROM into the RAM and then executes the program.

The controller 50 includes an arithmetic processing unit 51, a motor controller 52, a motor-operation data acquiring unit 53, and a force-measurement data acquiring unit 54. The arithmetic processing unit 51 outputs a current control value MVi to the motor controller 52. The motor-operation data acquiring unit 53 outputs, to the arithmetic processing unit 51, a current detection value PVi that is a current value of the drive current that is supplied by the motor drive unit 40 to the power unit 11 (motor 11m), a position detection value PVθ associated with the rotary shaft of the motor 11m, and a speed detection value PVv associated with the rotary shaft. The force-measurement data acquiring unit 54 outputs, to the arithmetic processing unit 51, a grip-force detection value PVf associated with the grip force F, which is received from the grip target TGT and is detected by the force detector 30. The details of each component will be described below.

### (Arithmetic Processing Unit 51)

The arithmetic processing unit 51 calculates the operational value for operating the drive unit 10 such that a control value becomes a target value. Specifically, the arithmetic processing unit 51 calculates the current control value MVi such that the grip-force detection value PVf as the control value becomes a grip force value used as the target value. The details of the arithmetic processing unit 51 are described below. In the arithmetic processing unit 51 according to the present embodiment, the current control value MVi is output as the operational value, but the operational value of power, a voltage, or the like may be used based on an object to be controlled, instead of using the current.

### (Motor Controller 52)

The motor controller 52 outputs the operational value for operating the power unit 11, specifically the motor 11m to the motor drive unit 40. In detail, the motor controller 52 performs a conversion to a current control signal Ip that can be input to the motor drive unit 40, based on the current control value MVi output from the arithmetic processing unit 51. Then, the motor controller 52 outputs the current control signal Ip that is obtained in the conversion, to the motor drive unit 40.

The motor controller 52 may output an analog signal as the current control signal Ip, such as a voltage signal or a current signal, as long as the current control signal Ip can be input to the motor drive unit 40. Alternatively, the motor controller 52 may output a digital signal as the current control signal Ip. The motor drive unit 40 provides supplied power Pd to the motor 11m of the power unit 11 based on the current control signal Ip.

### (Motor-Operation Data Acquiring Unit 53)

The motor-operation data acquiring unit 53 acquires motor operation data related to an operational state of the power unit 11, from the power unit 11 and the motor drive unit 40. Specifically, the motor-operation data acquiring unit 53 acquires, from the motor drive unit 40, the drive current value Im that is derived from the supplied power Pd that is provided to the power unit 11 by the motor drive unit 40. The motor-operation data acquiring unit 53 acquires position information Om and speed information vm of the rotary shaft of the motor 11m, from the encoder 11e.

The motor-operation data acquiring unit 53 may acquire the drive current value Im from the motor drive unit 40, for example, by using an analog signal or a digital signal. Similarly, the motor-operation data acquiring unit 53 may acquire, from the encoder 11e, each of the position information Om and the speed information vm, for example, by using the analog signal or the digital signal.

The motor-operation data acquiring unit 53 outputs the current detection value PVi to the arithmetic processing unit 51 based on the acquired drive current value Im. The motor-operation data acquiring unit 53 outputs a position detection value PVθ to the arithmetic processing unit 51, based on the acquired position information θm. Further, the motor-operation data acquiring unit 53 outputs a speed detection value PVv to the arithmetic processing unit 51, based on the acquired speed information vm.

### (Force-Measurement Data Acquiring Unit 54)

The force-measurement data acquiring unit 54 acquires measurement data of the grip force F from the force detector 30. Specifically, the force-measurement data acquiring unit 54 acquires a first grip force value Fma from the first force sensor 31a. The force-measurement data acquiring unit 54 acquires a second grip force value Fmb from the second force sensor 31b.

The force-measurement data acquiring unit 54 may acquire the first grip force value Fma from the first force sensor 31a, for example, by using the analog signal or the digital signal. Similarly, the force-measurement data acquiring unit 54 may acquire the second grip force value Fmb from the second force sensor 31b, for example, by using the analog signal or the digital signal.

The force-measurement data acquiring unit 54 outputs the grip-force detection value PVf to the arithmetic processing unit 51, based on the acquired first grip force value Fma and second grip force value Fmb. For example, the force-measurement data acquiring unit 54 may output an average grip force value of the first grip force value Fma and the second grip force value Fmb as the grip-force detection value PVf.

### <Details of Processing of Arithmetic Processing Unit 51>

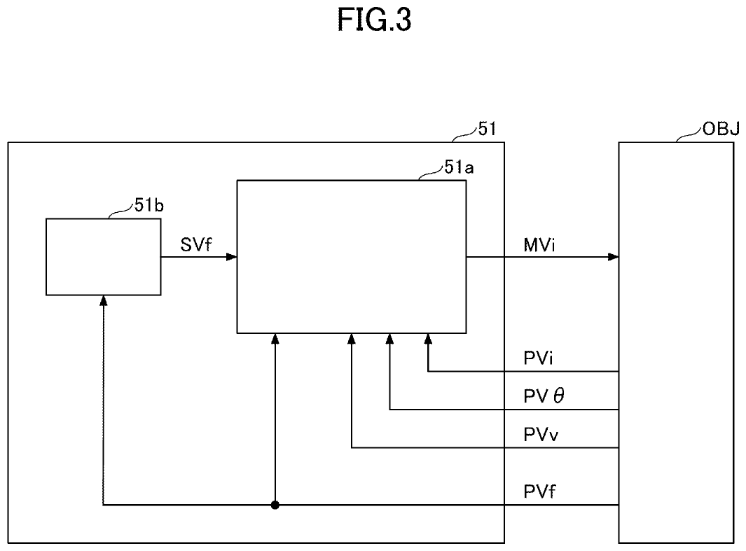

The process by the arithmetic processing unit 51, in other words, steps in a control method executed by the gripping device 1 will be described below in detail. FIG. 3 is a diagram illustrating a functional configuration of the arithmetic processing unit 51 included in the controller 50 of the gripping device 1 according to the first embodiment. In FIG. 3, components provided outside the arithmetic processing unit 51 are collectively shown as objects OBJ to be controlled by the arithmetic processing unit 51. The objects OBJ include, for example, the drive unit 10, the force detector 30, the motor drive unit 40, the motor controller 52, the motor-operation data acquiring unit 53, and the force-measurement data acquiring unit 54.

The arithmetic processing unit 51 determines a force command value SVf of the grip force F. The arithmetic processing unit 51 calculates the current control value MVi such that the grip-force detection value PVE matches the force command value SVf. The arithmetic processing unit 51 uses the current detection value PVi, the position detection value PVθ, and the speed detection value PVv to calculate the current control value MVi.

The arithmetic processing unit 51 includes an operational value calculator 51a and a force command generator 51b.

[Operational Value Calculator 51a]

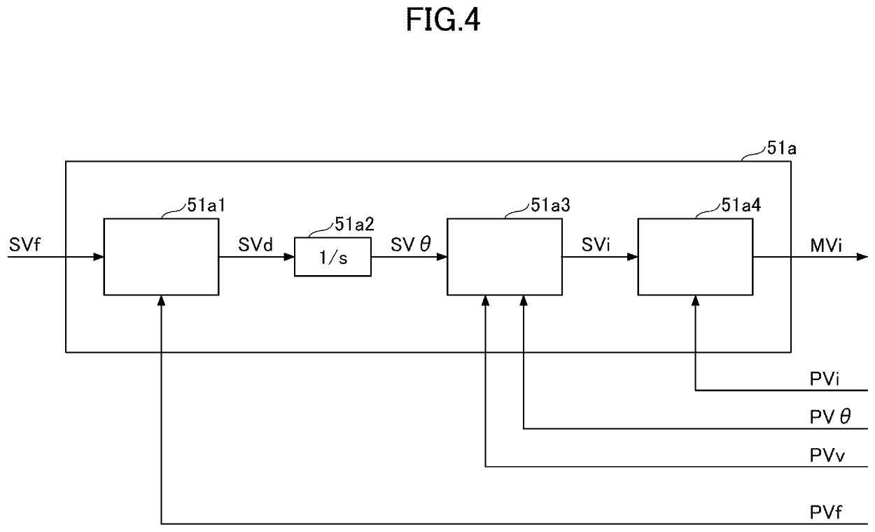

The operational value calculator 51a calculates the current control value MVi such that the grip-force detection value PVf matches the force command value SVf that the force command generator 51b sets. FIG. 4 is a diagram illustrating a functional configuration of the operational value calculator 51a of the arithmetic processing unit 51 included in the controller 50 of the gripping device 1 according to the first embodiment. In a block diagram, “1/s” expresses the integral.

The operational value calculator 51a includes an admittance processing unit 51al, an integration operator 51a2, a position-and-speed calculator 51a3, and a current calculator 51a4. Each of these arithmetic components will be described as follows.

### (Admittance Processing Unit 51a1)

The admittance processing unit 51al converts the force command value SVf into a displacement command value SVd. The admittance processing unit 51a1 calculates (generates) the displacement command value SVd such that the grip-force detection value PVf matches the force command value SVf. FIG. 5 is a diagram for describing a functional configuration of the admittance processing unit 51al of the arithmetic processing unit 51 included in the controller 50 of the gripping device 1 according to the first embodiment.

The admittance processing unit 51al controls parameters in virtual mass-spring-damper systems by solving a differential equation shown in Equation 1. Here, ΔF is difference between the force command value SVf and the grip-force detection value PVf, M (gain K11) is the weight, C (gain K12) is a damping coefficient for the damper, K (gain K13) is a spring constant for the spring, and x is displacement.

$$\begin{matrix}[ Equation 1 ] & \\ Δ F = M \frac{{d}^{2} x}{{dt}^{2}} + C \frac{dx}{dt} + Kx & ( EQUATION 1 )\end{matrix}$$

The admittance processing unit 51a1 calculates the difference between the force command value SVf and the grip-force detection value PVf, by an addition-and-subtraction block A11. Then, a result of the calculation by an integration block B11 (gain K11) is processed by a gain block B13 (gain K12), and then the resulting value is fed back to an addition-and-subtraction block A13. The result of the process by the integration block B11 is processed by an integration block B12, and a processed result is processed by a gain block B14 (gain K13) and the resulting value is fed back to the addition-and-subtraction block A12. Then, a processed result is output as the displacement command value SVd. In addition to the above admittance control by the admittance processing unit 51a1, for example, a force control in which the displacement command value SVd is determined based on the grip-force detection value PVE, using only the spring constant K may be performed.

The admittance processing unit 51a1 is an example of a force control calculator that converts the force command value SVf to the displacement command value SVd. A method of converting the command value SVf into the displacement command value SVd is not limited to a method executed by the admittance processing unit 51a1, and various approaches can be adopted.

### (Integration Operator 51a2)

The integration operator 51a2 integrates the displacement command value SVd that is output from the admittance processing unit 51al, and changes the displacement command value to a position command value SVθ. With use of the admittance processing unit 51a1 and the integration operator 51a2, positions of the first finger 21a and the second finger 21b are adjusted such that the grip-force detection value PVf matches the force command value SVf.

### (Position-and-Speed Calculator 51a3)

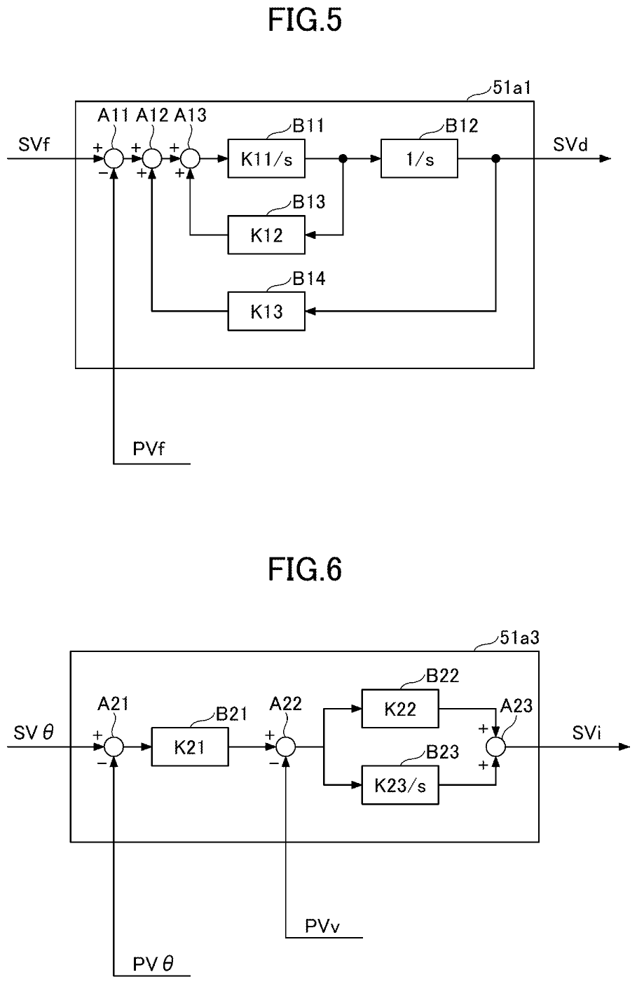

The position-and-speed calculator 51a3 calculates a current command value SVi such that the first finger 21a and the second finger 21b are disposed at positions that are identified by a position command value SVθi that is output from the addition-and-subtraction block A1, and then the position-and-speed calculator 51a3 outputs the current command value SVi. The position-and-speed calculator 51a3 calculates (generates) the current command value SVi such that the position detection value PVθ matches the position command value SVθi. Specifically, the position-and-speed calculator 51a3 performs P (proportional) control for the position, and performs PI (proportional-integral) control for the speed. FIG. 6 is a diagram illustrating a functional configuration of the position-and-speed calculator 51a3 of the arithmetic processing unit 51 included in the controller 50 of the gripping device 1 according to the first embodiment.

The position-and-speed calculator 51a3 determines a difference between the position command value SVθ and the position detection value PVθ, by using an addition-and-subtraction block A21. Then, the position-and-speed calculator 51a3 performs a calculation by a gain block B21 (gain K21), and determines a difference from the speed detection value PVv, by using an addition-and-subtraction block A22. Then, the position-and-speed calculator 51a3 processes the determined difference by a gain block B22 (gain K22) and an integration block B23 (gain K23), and adds a processed result by an addition-and-subtraction block A23. Then, the position-and-speed calculator 51a3 outputs the current command value SVi. Gains including the gain K21 and the like are appropriately determined in consideration of a system response and the like.

### (Current Calculator 51a4)

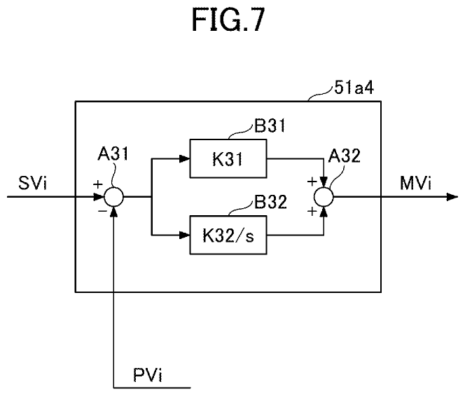

The current calculator 51a4 converts the current command value SVi output from the position-and-speed calculator 51a3 to a current control value MVi. The current calculator 51a4 calculates (generates) the current control value MVi such that the current detection value PVi matches the current command value SVi. Specifically, the current calculator 51a4 performs PI control for the current. FIG. 7 is a diagram illustrating a functional configuration of the current calculator 51a4 of the arithmetic processing unit 51 included in the controller 50 of the gripping device 1 according to the first embodiment.

The current calculator 51a4 determines a difference between the current command value SVi and the current detection value PVi, by using the addition-and-subtraction block A31. Then, the current calculator 51a4 processes the determined difference by the gain block B31 (gain K31) and the integration block B32 (gain K32), and adds a processed result by the addition-and-subtraction block A32. Then, the current calculator 51a4 outputs the current control value MVi.

[Force Command Generator 51b]

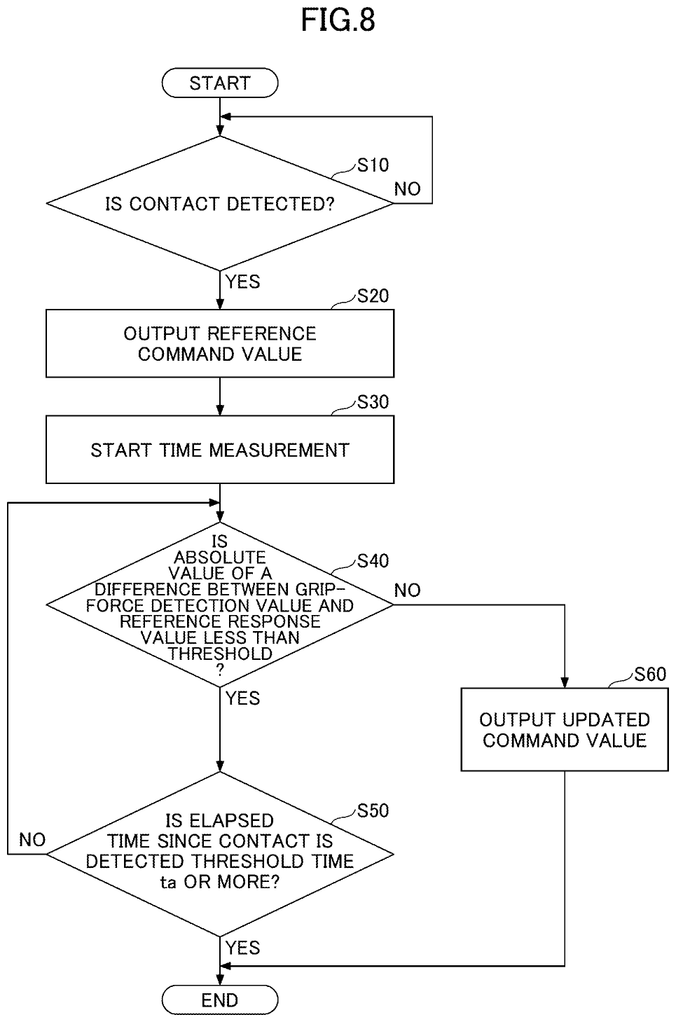

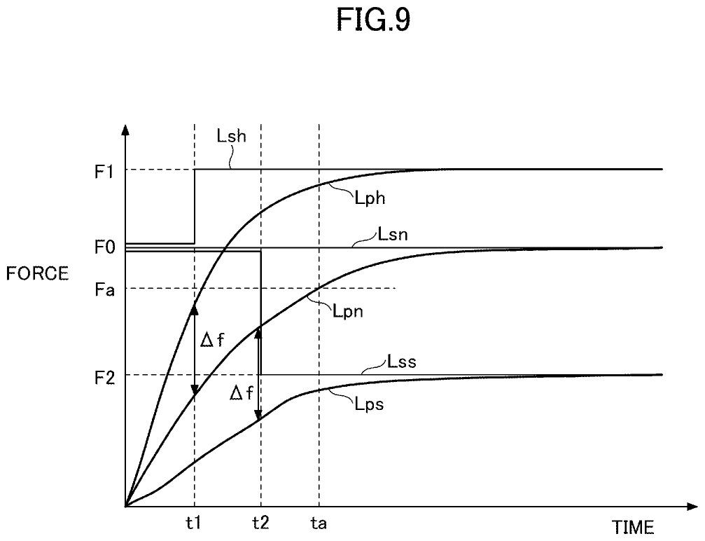

The force command generator 51b generates the force command value SVf based on the grip-force detection value PVf. FIG. 8 is a flowchart for describing a process by the force command generator 51b of the arithmetic processing unit 51 included in the controller 50 of the gripping device 1 according to the first embodiment. FIG. 9 is a diagram for describing the operation by the gripping device 1 according to the first embodiment.

The vertical axis in FIG. 9 expresses a force value indicative of each of the force command value SVf and the grip-force detection value PVf. The horizontal axis in FIG. 9 expresses the time from the detecting of the contact.

### (Step S10)

First, the force command generator 51b determines whether the contact of the first finger 21a and the second finger 21b of the grasper 20 with the grip target TGT is detected. For example, if the grip-force detection value PVf is greater than a predetermined value, the force command generator 51b determines that the first finger 21a and the second finger 21b of the grasper 20 are contacted.

If the force command generator 51b detects that the first finger 21a and the second finger 21b contact the grip target TGT (Yes in step S10), the force command generator 51b proceeds to step S20. If the force command generator 51b does not detect that the first finger 21a and the second finger 21b contact the grip target TGT (No in step S10), the force command generator 51b repeats step S10.

### (Step S20)

Next, the force command generator 51b outputs a reference command value F0 to the operational value calculator 51a as the force command value SVf. The operational value calculator 51a calculates the current control value MVi, while using the reference command value F0 as the force command value SVf.

### (Step S30)

Next, the force command generator 51b starts time measurement. It is desirable that the step S30 is performed with the step S20 simultaneously or is performed as soon as possible after the step S20 is performed.

### (Step S40)

Next, the force command generator 51b determines whether an absolute value of the difference between the grip-force detection value PVf and a reference response value is less than a threshold. Here, the reference response value is a given grip-force detection value PVf with respect to the time from a timing at which the grip target TGT having a reference hardness is contacted while gripping the grip target TGT. For example, as the reference response value, an actually measured value or a theoretically obtained value may be used. Any value may be set as the reference response value.

In FIG. 9, a value with respect to the time identified by the reference response value is indicated by a line Lpn. When the grip-force detection value PVf is greater than the value indicated by the line Lpn, it is estimated that the grip target TGT is harder than the reference hardness. Further, when the grip-force detection value PVf is less than the value indicated by the line Lpn, it is estimated that the grip target TGT is softer than the reference hardness.

For example, in FIG. 9, a line Lph indicates the grip-force detection value PVf that is obtained when the grip target TGT that is harder than the reference hardness is gripped. A line Lps indicates the grip-force detection value PVf that is obtained when the grip target TGT that is softer than the reference hardness is gripped.

If the absolute value of the difference between the grip-force detection values PVf and the reference response value is less than the threshold (Yes in step S40), the force command generator 51b proceeds to step S50. If the absolute value of the differences between the grip-force detection value PVf and the reference response value is greater than or equal to the threshold (No in step S40), the force command generator 51b proceeds to step S60.

### (Step S50)

Next, the force command generator 51b determines whether an elapsed time since the detecting of the contact is longer than or equal to threshold time ta. If the elapsed time since the detecting of the contact is longer than or equal to the threshold time ta (Yes in step S50), the force command generator 51b terminates the process. If the elapsed time since the detecting of the contact is shorter than the threshold time ta (No in step S50), the force command generator 51b returns to step S40, and then repeats the process.

### (Step S60)

If the absolute value of the difference between the grip-force detection value PVf and the reference response value is greater than or equal to the threshold (No in step S40), the force command generator 51b changes the force command value SVf to an updated command value, and then outputs the updated command value. For example, the force command generator 51b increases the updated command value when the grip target TGT is harder than a reference-grip target TGT. By setting the updated command value to be greater than the reference command value, the gripping device 1 can strongly grip the hard grip target TGT. Further, the force command generator 51b sets a smaller updated command value when the grip target TGT is softer than the reference-grip target TGT. By setting the updated command value to be less than the reference command value, the gripping device 1 can gently grip a soft grip target TGT.

The operation of the gripping device 1 according to the first embodiment will be described below with reference to FIG. 9. A line Lpn indicates a time response identified by the reference response value. A line Lph indicates the grip-force detection value PVf that is obtained when the grip target TGT that is harder than a reference is gripped, and a line Lps indicates the grip-force detection value PVf that is obtained when the grip target TGT having hardness that is softer than the reference is gripped. A line Lsn indicates the reference command value. A line Lsh indicates the force command value SVf that is obtained when the grip target TGT that is harder than the reference is gripped, and a line Lss indicates the force command value SVf that is obtained when the grip target TGT that is softer than the reference is gripped. The line Lsh and the line Lss are shown to be shifted up and down with respect to the reference command value F0, in order to clarify the difference from the line Lsn.

When the first finger 21a and the second finger 21b contact the grip target TGT, the grip-force detection value PVf increases over time. Here, when the grip target TGT is harder than the reference hardness, a great grip-force detection value PVf is obtained early compared to the reference response value (line Lph). When the grip target TGT is softer than the reference hardness, the grip-force detection value PVf is less than the reference response value (line Lps).

Here, it is assumed that at time t1, the absolute value of the difference between the line Lph and the line Lpn, that is, the absolute value of the difference between the grip-force detection value PVf and the reference response value become greater than or equal to a threshold Δf. In this case, as indicated by a line Lsh, in step S60, the force command generator 51b changes the force command value SVf from the reference command value F0 to an updated command value F1.

Further, it is assumed that at time t2, the absolute value of the difference between the line Lps and the line Lpn, that is, the absolute value of the difference between the grip-force detection value PVf and the reference response value is greater than or equal to the threshold Δf. In this case, as indicated by a line Lss, the force command generator 51b changes the force command value SVf from the reference command value F0 to an updated command value F2 in step S60.

Further, the time ta is assumed to be a time at which the reference response value is a determination value Fa, and for example, the determination value Fa (=0.8×F0) being a value that is 0.8 times the reference command value F0. If the absolute value of the difference between the grip-force detection value PVf and the reference response value is not greater than or equal to the threshold Δf within a time period, the force command generator 51b terminates the process in step S50, and then holds the force command value SVf as the reference command value F0. The threshold time ta may be determined in consideration of processing time, the response, and the like.

Note that a given value of the updated command value may be set for each of a case where a target is harder than the reference and a case where the target is softer than the reference. The given value may be changed according to a time period that is taken until the above difference exceeds the threshold.

### <Action and Effect>

The gripping device 1 according to the first embodiment can change the grip force according to the hardness of the grip target TGT. Specifically, in the gripping device 1 according to the first embodiment, a hard grip target TGT can be gripped strongly, and a soft grip target TGT can be gripped gently. In this arrangement, in the gripping device 1 of the first embodiment, grip targets having different hardness characteristics can be held accurately and stably. In particular, the gripping device 1 according to the first embodiment is suitable for grasping grip targets TGT having a large difference in the hardness between the grip targets.

Also, in the gripping device 1 of the first embodiment, by performing the control using the grip-force detection value PVf detected by the force detector 30, the grip target TGT can be stably gripped by a constant grip force. Further, in the gripping device 1 of the first embodiment, by the control using the grip-force detection value PVf detected by the force detector 30, gripping can be stably performed by a weak grip force.

Further, in the gripping device 1 of the first embodiment, even if gripping positions of the first finger 21a and the second finger 21b change greatly, such that the first finger 21a and the second finger 21b are greatly influenced by cogging torque that depends on positions of a magnet and an iron core of the motor, the effect of the cogging torque of the motor, which is a disturbance that depends on the positions, can be compensated under the control by the admittance processing unit 51a1.

### Second Embodiment

The gripping device according to a second embodiment differs from the gripping device 1 according to the first embodiment in the process by the force command generator 51b.

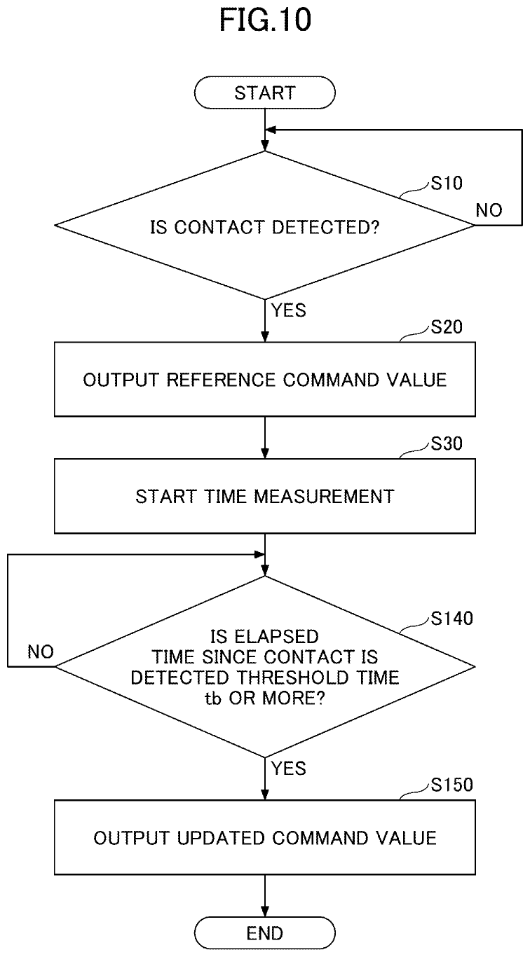

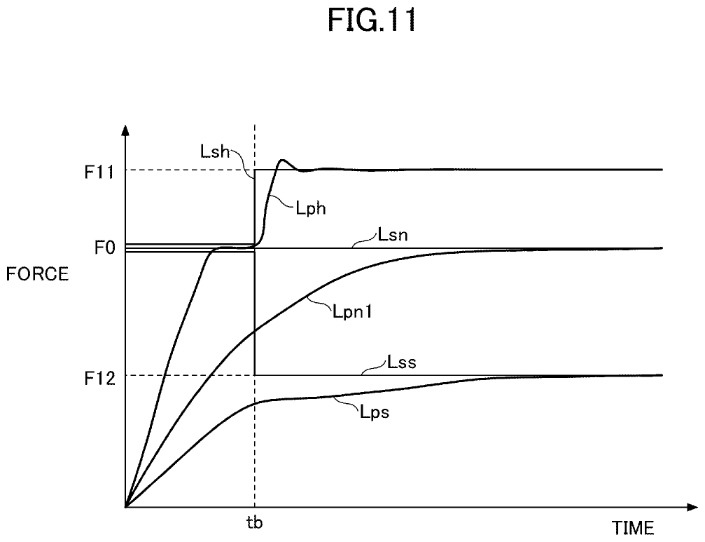

FIG. 10 is a flowchart for describing the process by the force command generator 51b of the arithmetic processing unit 51 included in the controller 50 of the gripping device according to the second embodiment. FIG. 11 is a diagram for describing the operation of the gripping device according to the second embodiment.

The vertical axis in FIG. 11 expresses each of the force command value SVf and the grip-force detection value PVf. The horizontal axis in FIG. 11 expresses the time from the detecting of the contact.

The process in step S10, step S20, and step S30 is the same as the process by the force command generator 51b of the gripping device 1 according to the first embodiment, and accordingly the description thereof is omitted.

### (Step S140)

The force command generator 51b determines whether the elapsed time since the detecting of the contact is longer than or equal to a threshold time tb. In other words, the force command generator 51b determines whether a predetermined time has elapsed. If the elapsed time since the detecting of the contact is longer than or equal to the threshold time tb (Yes in step S140), the force command generator 51b proceeds to step S150. In other words, the force command generator 51b proceeds to step S150 after the predetermined time has elapsed since the contact is detected. If the elapsed time since the detecting of the contact is shorter than the threshold time tb (No in step S140), the force command generator 51b repeats the process in step S140. The threshold time tb may be appropriately determined to be within the range that allows for the determination.

### (Step S150)

The force command generator 51b outputs an updated command value based on the grip-force detection value PVf that is obtained at the threshold time. For example, if a greater grip-force detection value PVf is obtained at the threshold time, it is determined that the grip target TGT is hard. Then, the power command generator 51b changes the power command value SVf to the updated command value that is greater than the reference command value. Further, if a smaller grip-force detection value PVE is obtained at the threshold time, it is determined that the grip target TGT is softer than the reference hardness. Then, the power command generator 51b changes the power command value SVf to the updated command value that is less than the reference command value. When the process in step S150 is terminated, the force command generator 51b terminates the process.

The operation of the gripping device 1 according to the second embodiment will be described below with reference to FIG. 11. A line Lpn1 indicates the grip-force detection value PVf obtained when the grip target TGT having the reference hardness is gripped. A line Lph indicates the grip-force detection value PVf obtained when the grip target TGT that is harder than the reference is gripped, and a line Lps indicates the grip-force detection value PVf obtained when the grip target TGT that is softer than the reference is gripped. A line Lsn indicates the reference command value. A line Lsh indicates the force command value SVf obtained when the grip target TGT that is harder than the reference is gripped, and a line Lss indicates the force command value SVf obtained when the grip target TGT that is softer than the reference is gripped. The line Lsh and the line Lss are shown to be shifted up and down with respect to the reference command value F0, in order to clarify the difference from the line Lsn.

When the first finger 21a and the second finger 21b contact the grip target TGT, the grip-force detection value PVf increases over time. Here, when the grip target TGT is harder than the reference hardness, a greater grip-force detection value PVf is obtained early compared to the reference response value (line Lph). When the grip target TGT is softer than the reference hardness, the grip-force detection value PVf is less than the reference response value (line Lps).

The power command generator 51b changes the power command value SVf to a given updated command value, in accordance with the gripping-power detection value PVf obtained at the threshold time tb. For example, when the grip target TGT that is harder than the reference hardness is gripped, a greater grip-force detection value PVf is obtained at the threshold time tb. In this case, the force command generator 51b changes the force command value SVf from the reference command value F0 to the updated command value F11 that is greater than the reference command value F0. For example, when the grip target TGT that is softer than the reference hardness is gripped, a smaller grip-force detection value PVf is obtained at the threshold time tb. In this case, the force command generator 51b changes the force command value SVf from the reference command value F0 to the updated command value F12 that is less than the reference command value F0.

A given value of the updated command value may be set to a first updated command value when the grip-force detection value PVf obtained at the threshold time tb is 0.8 times or more the reference command value F0, and when the grip-force detection value PVf is 0.4 times or less the reference command value F0, the given value may be set to a second updated command value. If the grip-force detection value PVf is greater than 0.4 times and less than 0.8 times the reference command value F0, the reference command value F0 may be used as the updated command value without changing the reference command value F0.

A given value of the updated command value may be determined, for example, based on the grip-force detection value PVf obtained at the threshold time tb. For example, the given value of the updated command value may be determined by Equation 2. In Equation 2, F0 expresses a given value as the reference command value, and PVf expresses a given value as the detected grip force value PVf at the threshold time tb.

$$F 0 + coefficient \times ( PVf - 0.5 \times F 0 ) \qquad ( Equation 2 )$$

### <Action and Effect>

The gripping device according to the second embodiment can provide the same action and effect as described in the gripping device according to the first embodiment.

### Third Embodiment

The gripping device according to a third embodiment differs from the gripping device according to the first embodiment and the second embodiment, in the process by the force command generator 51b.

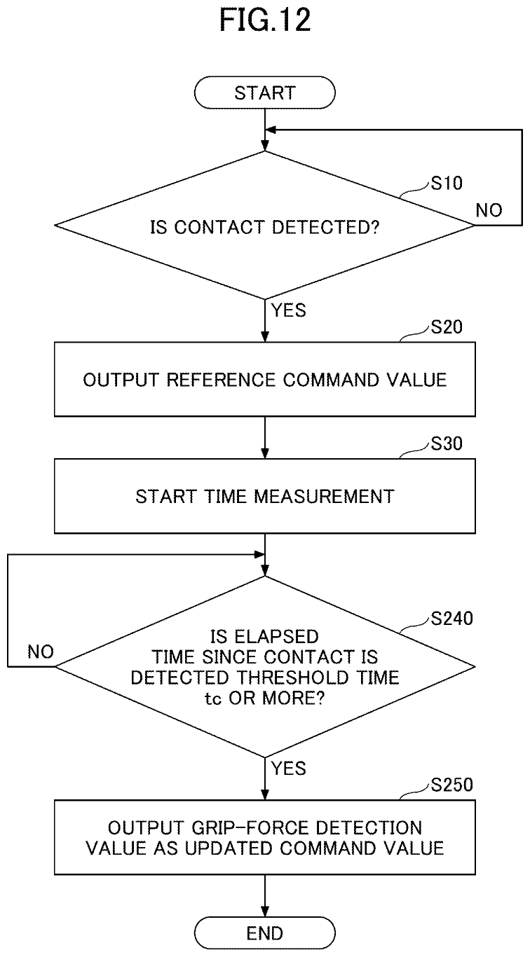

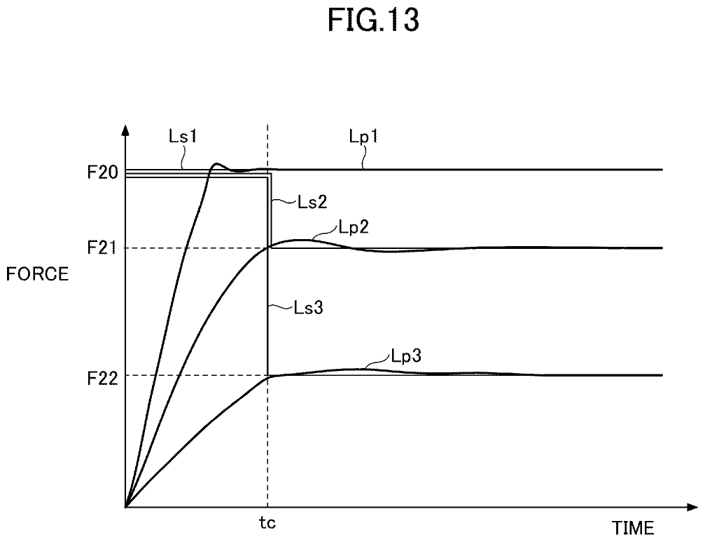

FIG. 12 is a flowchart for describing the process by the force command generator 51b of the arithmetic processing unit 51 included in the controller 50 of the gripping device according to the third embodiment. FIG. 13 is a diagram illustrating the operation by the gripping device according to the third embodiment.

The vertical axis in FIG. 13 expresses each of the force command value SVf and the grip-force detection value PVf. The horizontal axis in FIG. 13 expresses the time from the detecting of the contact.

The process in step S10, step S20, and step S30 is the same as the process by the force command generator 51b of the gripping device 1 according to the first embodiment, and accordingly the description thereof is omitted.

In step S20, a reference command value F20, which is the grip-force detection value PVf obtained when the grip target TGT (first grip target) assumed to be the hardest target among given grip targets is gripped, is used as the reference command value.

### (Step S240)

The force command generator 51b determines whether the elapsed time since the detecting of the contact is longer than or equal to a threshold time tc. In other words, the force command generator 51b determines whether a predetermined time has elapsed. If the elapsed time since the detecting of the contact is longer than or equal to the threshold time tc (Yes in step S240), the force command generator 51b proceeds to step S250. In other words, the force command generator 51b proceeds to step S250 after the predetermined time has elapsed since the contact is detected. If the elapsed time since the detecting of the contact is less than the threshold time tc (No in step S240), the force command generator 51b repeats the process in step S240. The threshold time tc may be appropriately determined within the range that allows for the determination.

### (Step S250)

The force command generator 51b outputs the grip-force detection value PVf obtained at the threshold time tc as an updated command value. When the process in step S250 is terminated, the force command generator 51b terminates the process.

The operation by the gripping device according to the third embodiment will be described below with reference to FIG. 13. A line Lp1 indicates the grip-force detection value PVf obtained when a grip target TGT (first grip target) assumed to be the hardest target among given grip targets is gripped. A line Lp2 indicates the grip-force detection value PVf obtained when a grip target TGT (second grip target) that is softer than the first grip target is gripped, and a line Lp3 indicates the grip-force detection value PVf obtained when a grip target TGT (third grip target) that is softer than the second grip target is gripped. Further, a line Ls1 indicates the power command value SVf obtained when the first grip target is gripped, a line Ls2 indicates the power command value SVf obtained when the second grip target is gripped, and a line Ls3 indicates the power command value SVf obtained when the third grip target is gripped. The line Ls2 is shown shifted with respect to the reference command value F20 and the threshold time tc to clarify the difference between lines. The line Ls3 is shown as shifted with respect to the reference command value F20 to clarify the difference between lines.

When the first finger 21a and the second finger 21b contact the grip target TGT, the grip-force detection value PVf increases over time. The force command generator 51b outputs the grip-force detection value PVf obtained at the threshold time to as the updated command value of the force command value SVf.

For example, when the first grip target is gripped, the grip-force detection value PVf is substantially the same as the reference command value F20 obtained at the threshold time tc, and thus the force command generator 51b outputs the reference command value F20 as the updated command value. When the second grip target is gripped, the force command generator 51b outputs the updated command value F21 that is the grip-force detection value PVf obtained at the threshold time tc. When the third grip target is gripped, the force command generator 51b outputs the updated command value F22 that is the grip-force detection value PVf obtained at the threshold time tc.

### <Action and Effect>

The gripping device according to the third embodiment can provide the same action and effect as described in the gripping device 1 according to the first embodiment. In particular, in the third embodiment, the process by in the force command generator 51b is simplified.

### Fourth Embodiment

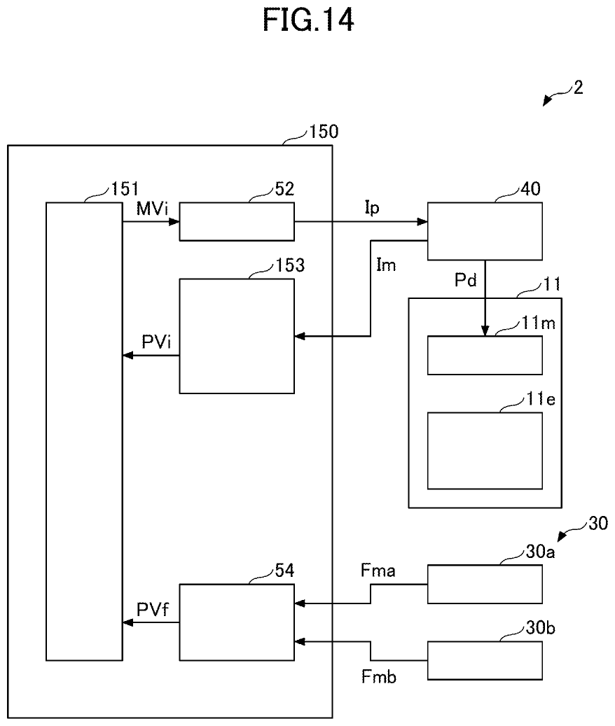

The gripping device according to a fourth embodiment includes a controller 150 instead of the controller 50 of the gripping device 1 according to the first embodiment. The gripping device according to the fourth embodiment includes an arithmetic processing unit 151 instead of the arithmetic processing unit 51 of the gripping device 1 according to the first embodiment. Further, the gripping device according to the fourth embodiment includes a motor-operation data acquiring unit 153 instead of the motor-operation data acquiring unit 53 of the gripping device 1 according to the first embodiment. FIG. 14 is a diagram for describing the functional configuration of the gripping device according to the fourth embodiment.

The motor-operation data acquiring unit 153 acquires, from the motor drive unit 40, a drive current value Im of supplied power Pd that the motor drive unit 40 provides to the power unit 11 (motor 11m). Then, the motor-operation data acquiring unit 153 outputs a current detection value PVi to the arithmetic processing unit 151.

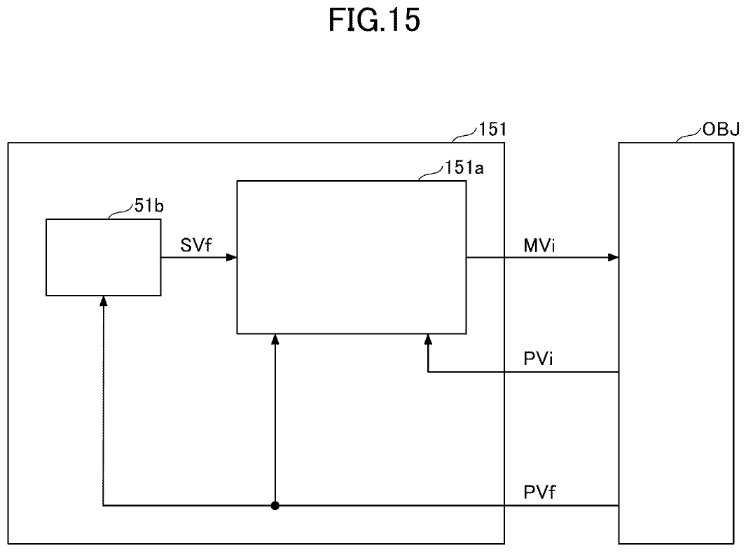

The arithmetic processing unit 151 includes an operational value calculator 151a and a force command generator 51b. The arithmetic processing unit 151 differs from the arithmetic processing unit 51 of the gripping device 1 according to the first embodiment in that the arithmetic processing unit 151 includes the operational value calculator 151a instead of the operational value calculator 51a. FIG. 15 is a diagram for describing the functional configuration of the arithmetic processing unit 151 included in the controller of the gripping device according to the fourth embodiment.

The arithmetic processing unit 151 calculates an operation amount enabling the operation of the drive unit 10 such that a control value becomes a target value. Specifically, the arithmetic processing unit 151 calculates the current operation value MVi such that the grip-force detection value PVf as the control value becomes a grip force value of the target value.

[Operational Value Calculator 151a]

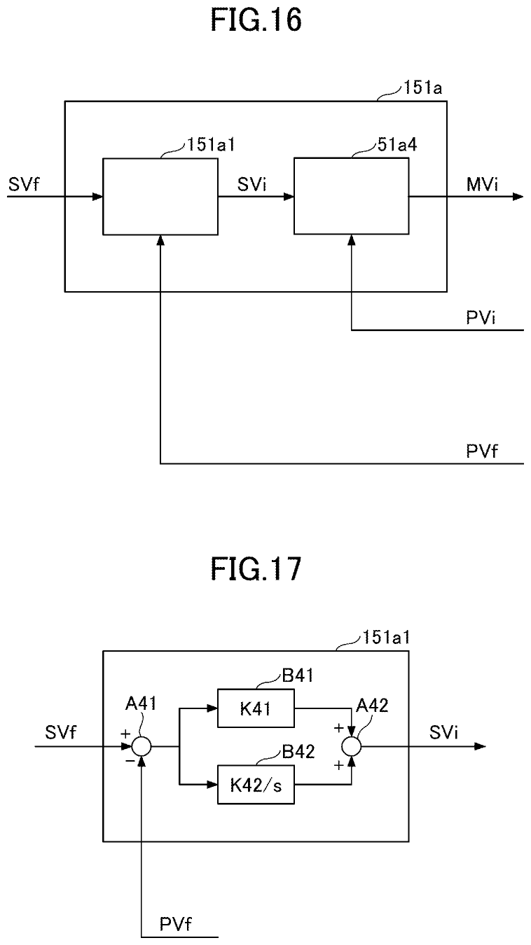

The operational value calculator 151a calculates the current operation value MVi such that the grip-force detection value PVf matches the force command value SVf that is set by the force command generator 51b. FIG. 16 is a diagram for describing the functional configuration of the operational value calculator 151a of the arithmetic processing unit 151 included in the controller 150 of the gripping device according to the fourth embodiment.

The operational value calculator 151a includes a force calculator 151al and a current calculator 51a4. Hereinafter, the force calculator 151al will be described.

### (Force Calculator 151a1)

The force calculator 151a1 converts the power command value SVf into the current command value SVi. The force calculator 151a1 calculates (generates) the current command value SVi such that the grip-force detection value PVf matches the force command value SVf. FIG. 17 is a diagram for describing the functional configuration of the force calculator 151a1 of the arithmetic processing unit 151 included in the controller 150 of the gripping device according to the fourth embodiment.

The force calculator 151a1 calculates the current command value SVi so as to reduce a difference between the force command value SVf and the grip-force detection value PVf. Specifically, the force calculator 151a1 performs PI control on the force. The force calculator 151a1 obtains a difference between the power command value SVf and the grip-power detection value PVf by an addition-and-subtraction block A41. Then, the force calculator 151a1 performs a calculation by a gain block B41 (gain K41) and an integration block B42 (gain K42), and adds calculation results by an addition-and-subtraction block A42. Then, the force calculator 151a1 outputs the current command value SVi.

### <Action and Effect>

In the gripping device according to the fourth embodiment, the grip force can change according to the hardness of the grip target TGT. Specifically, the gripping device according to the fourth embodiment can grip a hard grip target TGT strongly, and can grip a soft grip target TGT gently. In this arrangement, in the gripping device of the fourth embodiment, grip targets having different hardness measurements can be accurately and stably held.

Also, in the gripping device of the fourth embodiment, the grip target TGT can be stably gripped by a constant grip force, under the control that uses the grip-force detection value PVf that is obtained by performing detection through the force detector 30. Further, in the gripping device of the fourth embodiment, the gripping can be stably performed by a weak grip force under the control that uses the grip-force detection value PVf detected by the force detector 30.

### Fifth Embodiment

In the gripping device according to a fifth embodiment, in order to perform an operation at high speed until the gripping device contacts the grip target TGT, the control is performed by position and speed control before the gripping device contacts the grip target TGT, and the control is performed by force control after the gripping device contacts the grip target TGT.

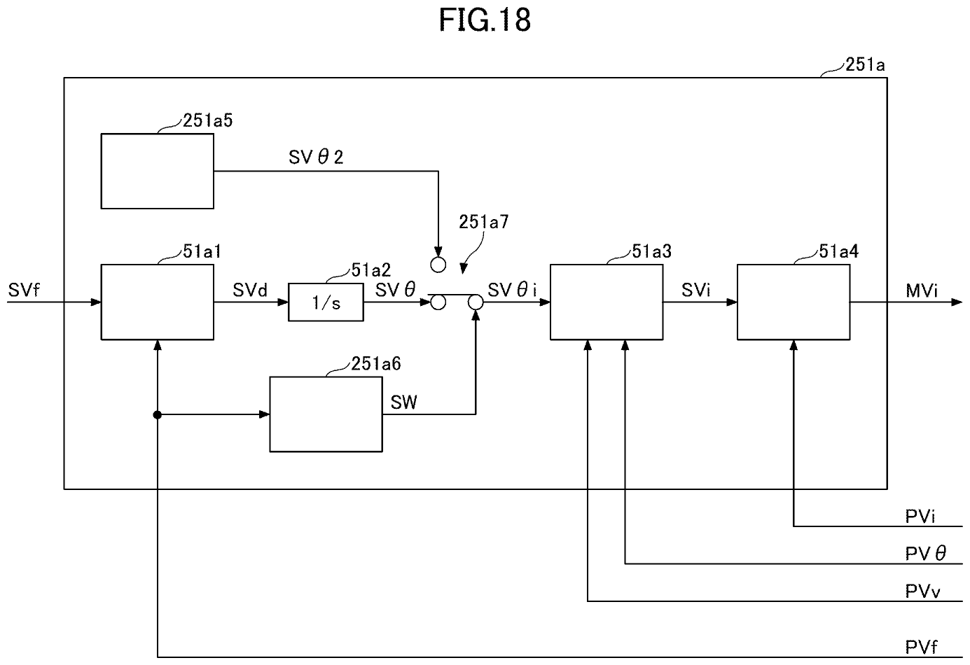

The gripping device according to the fifth embodiment includes an operational value calculator 251a instead of the operational value calculator 51a of the gripping device 1 according to the first embodiment. In the operational value calculator 251a, a position-command value generator 251a5, a contact determination unit 251a6, and a switching unit 251a7 are further included in the operational value calculator 51a. FIG. 18 is a diagram for describing the functional configuration of the operational value calculator 251a of the arithmetic processing unit included in the controller of the gripping device according to the fifth embodiment.

### (Position-Command Value Generator 251a5)

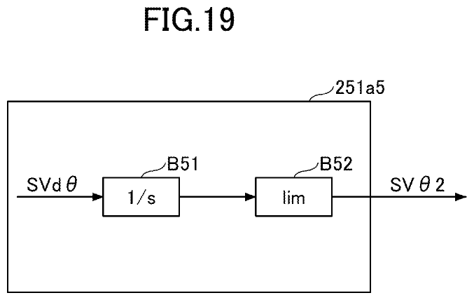

The position-command value generator 251a5 generates a position command value SVθ2 used in position control. The position-command value generator 251a5 calculates (generates) the position command value SVθ2 that changes at a constant change rate before the position command value SVθ2 becomes a constant value. FIG. 19 is a diagram for describing a functional configuration of the position-command value generator 251a5 of the operational value calculator 251a included in the controller of the gripping device according to the fifth embodiment.

The position-command value generator 251a5 calculates the position command value SVθ2 based on a position-displacement command value SVdθ. The position-displacement command value SVdθ corresponds to a differential of the position command value SVθ2. The position command value SVθ2 increases in proportion to time. The position command value SVθ2 indicates a distance between the first finger 21a and the second finger 21b. In accordance with an increasing position command value SVθ2, the distance between the first finger 21a and the second finger 21b is reduced. In this arrangement, the resulting value varies until the first finger 21a and the second finger 21b contact each other. That is, the value changes until there is no distance between the first finger 21a and the second finger 21b.

The position-command value generator 251a5 integrates the position-displacement command value SVdθ by using an integration block B51. Further, by a limiting block B52, the resulting value is set to a predetermined value or less. Specifically, the resulting value is set to a value or less that enables the first finger 21a and the second finger 21b to contact with each other. Then, the position-command value generator 251a5 outputs the position command value SVθ2.

A method of generating the position command value SVθ2 by the position-command value generator 251a5 described above is an example of a method of generating the position command value SVθ2. The position command value SVθ2 may be generated with any other approach.

### (Contact Determination Unit 251a6)

The contact determination unit 251a6 determines whether the grip target TGT contacts the first finger 21a and the second finger 21b, based on the grip-force detection value PVf. Then, a determination result is output to the switching unit 251a7 as a switch signal SW.

### (Switching Unit 251a7)

With use of the switch signal SW, the switching unit 251a7 outputs one of the position command value Svθ and the position command value SVθ2 to the position-and-speed calculator 51a3 as the position command value SVθi. One input of the switching unit 251a7 is connected to the integration operator 51a2, and the other input of the switching unit 251a7 is connected to the position-command value generator 251a5. An output of a switching unit 252a7 is connected to the position-and-speed calculator 51a3.

In the gripping device 1 according to the fifth embodiment, by the contact determination unit 251a6 and the switching unit 251a7, the control is changed before and after the first finger 21a and the second finger 21b contact the grip target TGT. Specifically, until the first finger 21a and the second finger 21b contact the grip target TGT, the position command value SVθ2 output from the position-command value generator 251a5 is input to the position-and-speed calculator 51a3 as the position command value SVθi, by using the switching unit 251a7. With this arrangement, until the first finger 21a and the second finger 21b contact the grip target TGT, the gripping device 1 according to the fifth embodiment controls the drive unit 10 by position and speed control.

In the gripping device 1 according to the fifth embodiment, the first finger 21a and the second finger 21b can move at high speed by controlling the drive unit 10 by position and speed control, until the first finger 21a and the second finger 21b contact the grip target TGT.

After the first finger 21a and the second finger 21b contact the grip target TGT, the position command value Svθ output from the integration operator 51a2 is input to the position-and-speed calculator 51a3 as the position command value SVθi, by using the switching unit 251a7. With this arrangement, as of the first finger 21a and the second finger 21b contacting the grip target TGT, the gripping device according to the fifth embodiment controls the drive unit 10 by force control.

In the gripping device 1 according to the fifth embodiment, after the first finger 21a and the second finger 21b contact the grip target TGT, the drive unit 10 is controlled by the force control. In this arrangement, the first finger 21a and the second finger 21b move slowly so that the grip target TGT can be softly gripped.

### <Action and Effect>

In addition to having the action and effect of the gripping device according to the first embodiment, in the control by the gripping device 1 according to the fifth embodiment, rapid position and speed control and fine force control can be performed.

### Sixth Embodiment

In order to operate at high speed before the grip target TGT is contacted, in the gripping device according to a sixth embodiment, the control is performed by position and speed control before the grip target TGT is contacted, and after the grip target TGT is contacted, the control is performed by force control.

The gripping device according to the sixth embodiment includes an operational value calculator 351a instead of the operational value calculator 51a of the gripping device 1 according to the first embodiment.

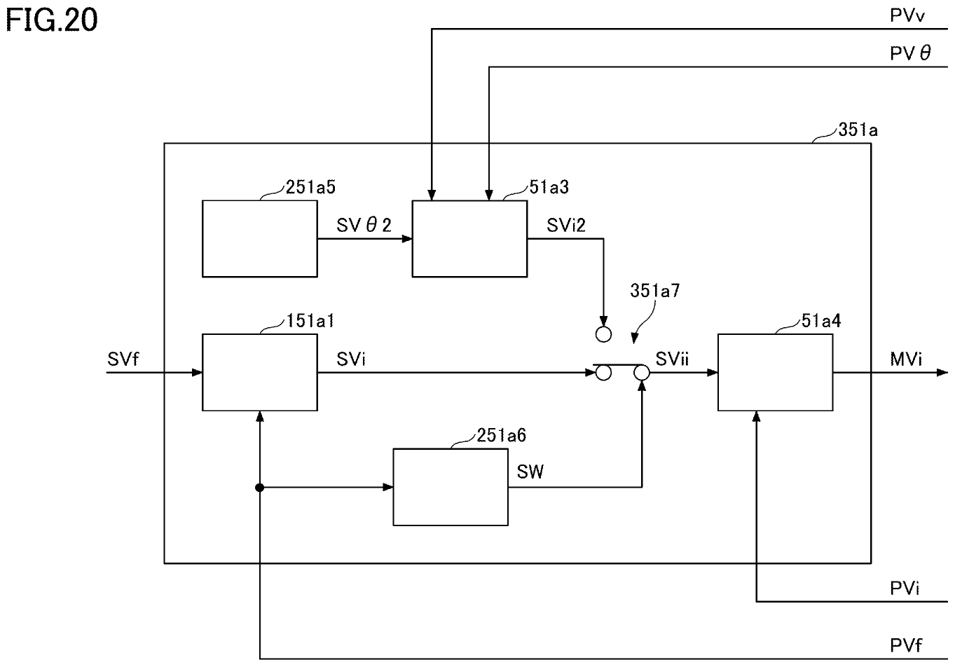

In the operational value calculator 351a, a position-command value generator 251a5, a contact determination unit 251a6, and a switching unit 351a7 are further included in the operational value calculator 151a of the gripping device according to the fourth embodiment. Also, a position-and-speed calculator 51a3 is included to convert the position command value SVθ2 that is output from the position-command value generator 251a5, to a current command value SVi2. FIG. 20 is a diagram for describing the functional configuration of the operational value calculator 351a of the arithmetic processing unit included in the controller of the gripping device according to the sixth embodiment.

### (Switching Unit 351a7)

The switching unit 351a7 outputs, as a current command value SVii, any one of the current command value SVi and the current command value SVi2 to the current calculator 51a4, based on the switch signal SW. One input of the switching unit 351a7 is connected to the force calculator 151a1, and the other input of the switching unit 351a7 is connected to the position-and-speed calculator 51a3. The output of the switching unit 352a7 is connected to the current calculator 51a4.

In the gripping device according to the sixth embodiment, by use of the contact determination unit 351a6 and the switching unit 351a7, the control changes before versus after the first finger 21a and the second finger 21b contact the grip target TGT. Specifically, before the first finger 21a and the second finger 21b contact the grip target TGT, the current command value SVi2 output by the position-and-speed calculator 51a3 is input to the current calculator 51a4 as the current command value SVii, by using the switching unit 351a7. In this arrangement, before the first finger 21a and the second finger 21b contact the grip target TGT, the gripping device according to the sixth embodiment controls the drive unit 10 by position and speed control.

In the gripping device according to the sixth embodiment, until the first finger 21a and the second finger 21b contact the grip target TGT, the drive unit 10 is controlled by position-and-speed control so that the first finger 21a and the second finger 21b can move at high speed.

After the first finger 21a and the second finger 21b contact the grip target TGT, the current command value SVi output by the force calculator 151al is input to the current calculator 51a4 as the current command value SVii by using the switching unit 351a7. With this arrangement, after the first finger 21a and the second finger 21b contact the grip target TGT, the gripping device according to the sixth embodiment controls the drive unit 10 by the force control.

In the gripping device according to the sixth embodiment, the drive unit 10 is controlled by the force control after the first finger 21a and the second finger 21b contact the grip target TGT. With this arrangement, the first finger 21a and the second finger 21b can move slowly, and the grip target TGT can be gripped gently.

### <Action and Effect>

In the control by the gripping device according to the sixth embodiment, in addition to having the action and effect of the gripping device according to the fourth embodiment, rapid position and speed control and fine force control can be performed.

### Seventh Embodiment

The gripping device according to a seventh embodiment includes an operational value calculator 451a instead of the operational value calculator 251a of the gripping device according to the fifth embodiment.

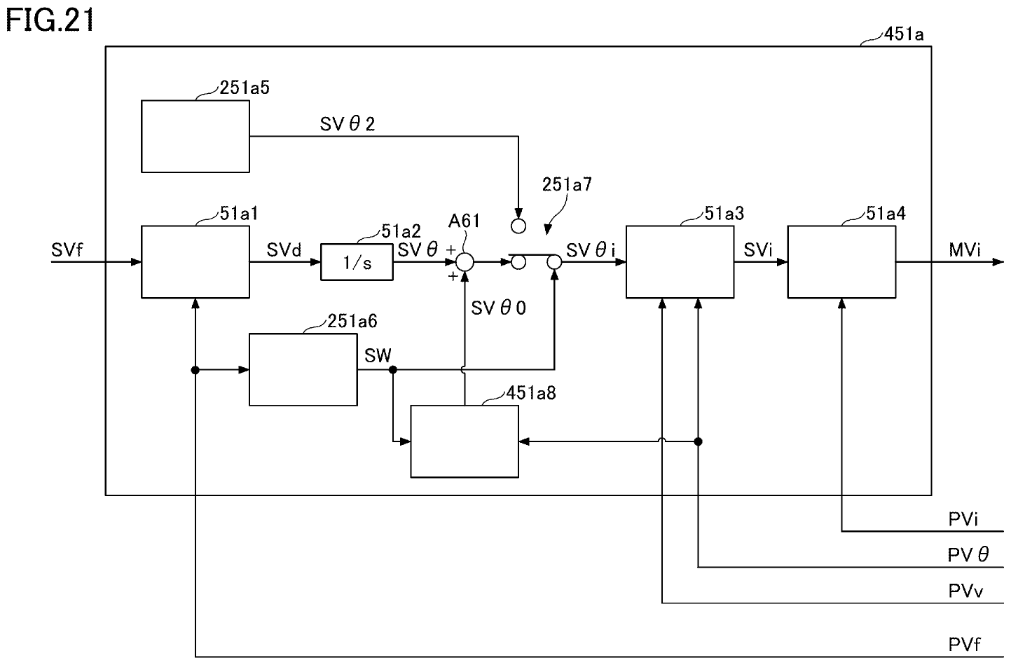

In the operational value calculator 451a, a value holder 451a8 and an addition-and-subtraction block A61 are further included in the operational value calculator 251a of the gripping device according to the fifth embodiment. FIG. 21 is a diagram for describing the functional configuration of the operational value calculator 451a of the arithmetic processing unit included in the controller of the gripping device according to the seventh embodiment.

### (Value Holder 451a8)

Based on the switch signal SW, the value holder 451a8 outputs the position detection value PVθ as a position command value SVθ0, when the grip target TGT contacts the first finger 21a and the second finger 21b.

### (Addition-and-Subtraction Block A61)

The addition-and-subtraction block A61 adds the position command value SVθ output from the integration operator 51a2 and the position command value SVθ0 output from the value holder 451a8. Then, the addition-and-subtraction block A61 outputs the position command value SVθi to the position-and-speed calculator 51a3.

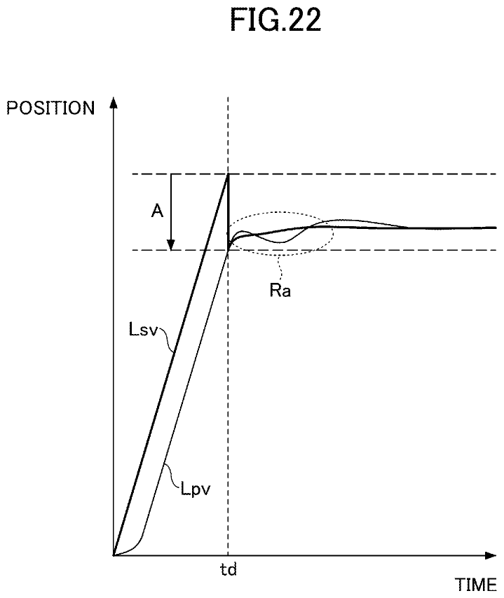

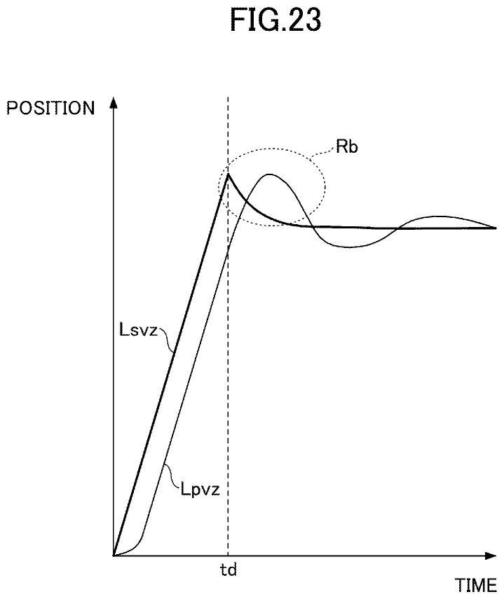

The operation of the gripping device according to the seventh embodiment will be described as follows. FIG. 22 is a diagram for describing the operation of the gripping device according to the seven embodiment. The vertical axis in FIG. 22 expresses position values relating to the position command value SVθ, the position detection value PVθ, and the like. The vertical axis in each of FIGS. 23, 24, and 25 expresses the position values as in FIG. 22. The horizontal axis in FIG. 22 expresses time from the starting of the operation. The horizontal axis in each of FIGS. 23, 24, and 25 expresses the time as in FIG. 22.

In FIG. 22, a line Lsv indicates the position command value SVθi that is input to the position-and-speed calculator 51a3, and a line Lpv indicates the position detection value PVθ. Time td indicates time at which the first finger 21a and the second finger 21b are in contact with the grip target TGT.

At the time td at which the first finger 21a and the second finger 21b are in contact with the grip target TGT, the operational value calculator 451a changes the position command value SVθ to be the same as the position detection value PVθ at the time td. That is, as indicated by an arrow A in FIG. 22, the position command value SVθ is changed to the position detection value PVθ at the time td. At the time td, the operational value calculator 451a changes the position command value SVθ to correspond to the position detection value PVθ at the time td. By use of the operational value calculator 451a at the time td at which the position command value SVθ is changed to be the same as the position detection value PVθ at the time td, variations in the position detection value PVθ can be reduced as indicated by Ra. Further, the convergence of the position detection value PVθ can be facilitated.

On the other hand, a case where there is no change in the position command value SVθ will be described below using a gripping device in a comparative example in FIG. 23. In the gripping device in the comparative example, the position command value SVθ does not change. In FIG. 23, a line Lsvz indicates the position command value SVθi that is input to the position-and-speed calculator 51a3 of the gripping device in the comparative example, and a line Lpvz indicates the position detection value PVθ that is used in the gripping device in the comparative example.

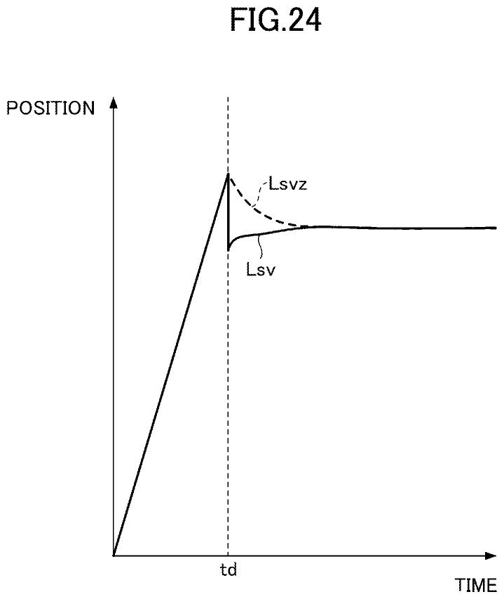

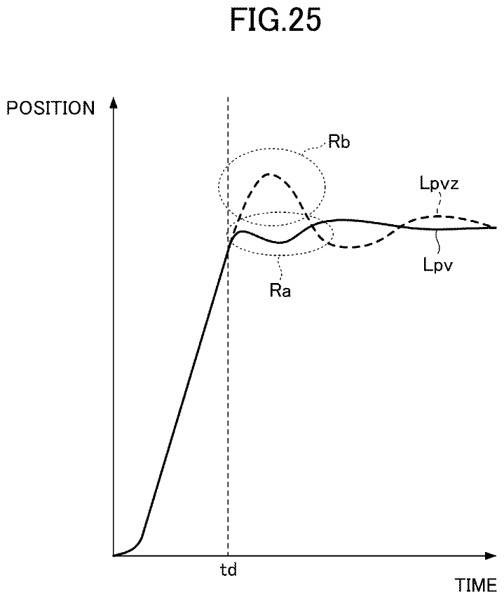

FIG. 24 is a graph showing position command values SVθ for the gripping device according to the seventh embodiment and the gripping device in the comparative example. Further, FIG. 25 is a graph illustrating position detection values PVθ for the gripping device according to the seventh embodiment and the gripping device in the comparative example.

In the gripping device in the comparative example, from the fact that the position command value SVθ is increased at the time td, hunting occurs significantly with respect to the position detection value PVθ, as indicated by Rb. In addition, the convergence of the position detection value PVθ is also delayed.

In the gripping device according to the seventh embodiment, hunting occurring when the control is changed can be suppressed, compared to the gripping device in the comparative example. By suppressing the hunting, the gripping device according to the seventh embodiment can grip the grip target TGT without greatly crushing the grip target TGT, after gripping the grip target TGT. Further, in the gripping device according to the seventh embodiment, after changing the control, the convergence can be made early, compared to the gripping device of the comparative example.

### <Action and Effect>

In addition to having the action and effect of the gripping device according to the fifth embodiment, the gripping device according to the seventh embodiment has the effect in which the grip target TGT can be prevented from being crushed when the grip target TGT is gripped.

Although the gripping device is described above according to the embodiments, the present invention is not limited to the above-described embodiments. Various modifications and improvements such as combinations with or substitutions of a portion or all of the other embodiments can be made within the scope of the present invention.

This application claims priority of Japanese Patent Application No. 2021-135159, filed on Aug. 20, 2021, the entire contents of which are incorporated herein by reference.

### DESCRIPTION OF THE REFERENCE NUMERAL

1 gripping device
10 drive unit
11 power unit
11e encoder
11m motor
20 grasper
21a first finger
21b second finger
30 force detector
31a first force sensor
31b second force sensor
40 motor drive unit
50, 150 controller
51, 151 arithmetic processing unit
51a, 151a, 251a operational value calculator
51a1 admittance processing unit
51a2 integration operator
51a3 position-and-speed calculator
51a4 current calculator
51b force command generator
52 motor controller
53, 153 motor-operation data acquiring unit
54 force-measurement data acquiring unit
151a1 force calculator
251a5 position-command value generator
251a6 contact determination unit
251a7, 252a7, 351a7, 352a7 switching unit
351a, 451a operational value calculator
451a8 value holder

1. A gripping device comprising:
a motor configured to rotate in accordance with an operational value;
a grasper including a first finger and a second finger, the grasper being configured to grip an object with the first finger and the second finger while changing a distance between the first finger and the second finger by using the motor;
a force detector configured to detect a grip force that enables the object to be gripped by the first finger and the second finger, upon occurrence of a condition in which the object is gripped by the first finger and the second finger; and
circuitry configured to control the operational value such that a magnitude of the grip force detected by the force detector matches a command value,
wherein the circuitry is configured to
set the command value as a reference command value to control the grasper based on the command value, and
change the command value as the reference command value to an updated command value, based on a change in the grip force that the force detector detects after the grasper grips the object.

2. The gripping device according to claim 1, wherein the circuitry is configured to
determine a difference between the grip force detected by the force detector and a reference response value, and
change the command value to the updated command value upon occurrence of a condition in which an absolute value of the difference is equal to or greater than a threshold.

3. The gripping device according to claim 2, wherein the circuitry is configured to
set the updated command value to be greater than the reference command value upon occurrence of a condition in which the detected grip force is greater than the reference response value, and
set the updated command value to be less than the reference command value upon occurrence of a condition in which the detected grip force is less than the reference response value.

4. The gripping device according to claim 1, wherein the circuitry is configured to change the command value to the updated command value, based on the grip force that the force detector detects after a preset time period.

5. The gripping device according to claim 4, wherein the circuitry is configured to
set the updated command value to be greater than the reference command value upon occurrence of a condition in which the detected grip force is greater than a reference response value, and
set the updated command value to be less than the reference command value upon occurrence of a condition in which the detected grip force is less than the reference response value.

6. The gripping device according to claim 4, wherein the circuitry is configured to update the updated command value to match the detected grip force.

7. A control method by a gripping device that includes
a motor configured to rotate in accordance with an operational value,
a grasper including a first finger and a second finger, and configured to grip an object with the first finger and the second finger while changing a distance between the first finger and the second finger by using the motor, and
a force detector configured to detect a grip force that enables the object to be gripped by the first finger and the second finger upon occurrence of a condition in which the object is gripped by the first finger and the second finger, the gripping device controlling the operational value such that a magnitude of the grip force detected by the force detector matches a command value, the control method comprising:
setting the command value as a reference command value to control the grasper based on the set command value; and
changing the command value as the reference command value to an updated command value, based on a change in the grip force that the force detector detects after the grasper grips the object.
